(19) United States
(12) Patent Application Publication
(10) Pub. No.: US 2018/0067310 A1
(43) Pub. Date: Mar. 8, 2018

(54) COMPACT WIDE FIELD OF VIEW (WFOV) HEAD UP DISPLAY (HUD) USING TWO FREE FORM MIRRORS AND DLP TECHNOLOGY

(71) Applicant: Panasonic Automotive Systems Company of America, Division of Panasonic Corporation of North America, Peachtree City, GA (US)

(72) Inventor: GERALD A. TANG-KONG, NEWNAN, GA (US)

(73) Assignee: Panasonic Automotive Systems Company of America, Division of Panasonic Corporation of North America

(21) Appl. No.: 15/692,643

(22) Filed: Aug. 31, 2017

Related U.S. Application Data
(60) Provisional application No. 62/385,086, filed on Sep. 8, 2016.

(51) Int. Cl. G02B 27/01; G02B 17/08; G02B 17/00; H04N 9/31

(52) U.S. Cl. CPC G02B 27/0101; G02B 17/0812; G02B 17/008; G02B 2027/0145; H04N 9/317; G02B 2027/0123; H04N 9/3144

(57) ABSTRACT

A head up display arrangement for a motor vehicle includes a picture generation unit generating an illuminated image. A first free form mirror is positioned to provide a first reflection of the illuminated image. A second free form mirror is positioned to receive the first reflection of the illuminated image and provide a second reflection of the illuminated image. A windshield of the motor vehicle is positioned to receive the second reflection of the illuminated image and provide a third reflection that is visible to a driver of the vehicle as a virtual image.

### CROSS-REFERENCED TO RELATED APPLICATIONS

This application claims benefit of U.S. Provisional Application No. 62/385,086 filed on Sep. 8, 2016, which the disclosure of which is hereby incorporated by reference in its entirety for all purposes.

### FIELD OF THE INVENTION

The disclosure relates to a head up display (HUD) in a motor vehicle.

### BACKGROUND OF THE INVENTION

A head up display emits light that reflects from the front windshield to be seen by the driver. The light appears to come from a virtual image in front of the driver and in front of the windshield.

Conventional head up displays create the virtual image by first using a display to create an image. Next, the light from the image is reflected from one or more mirrors, and then the light from the mirrors is reflected from the windshield. The mirrors are designed and positioned relative to the display so that the light seen by the driver, which is reflected from the windshield, appears to come from a virtual image that is outside of the vehicle. The mirrors and display are typically contained in a package that occupies a volume beneath the top surface of the dashboard.

A HUD with a wide field of view (WFOV) usually has a large package size which is difficult to fit into the instrument panel space between the instrument cluster and the windshield.

Presently, there is no existing configuration or devices that are automotive qualified and that meet the optical performance, package size, and cost for the WFOV required for an augmented reality (AR) HUD.

### SUMMARY

The present invention may provide a head up display (HUD) including two freeform mirrors and a picture generation unit (PGU) that utilizes digital light processing (DLP) technology for wide field of view (WFOV). DLP technology for wide field of view can be used for augmented reality and advanced driver assistance systems (ADAS) applications. The inventive configuration provides a small HUD envelope with increased flexibility for application to different vehicles with minimal changes being required.

The inventive HUD includes two free form mirrors, resulting in a minimal distance between the mirrors as compared to other mirror systems. This also results in a minimal HUD envelope size.

In one embodiment, the invention comprises a head up display arrangement for a motor vehicle, including a picture generation unit generating an illuminated image. A first free form mirror is positioned to provide a first reflection of the illuminated image. A second free form mirror is positioned to receive the first reflection of the illuminated image and provide a second reflection of the illuminated image. A windshield of the motor vehicle is positioned to receive the second reflection of the illuminated image and provide a third reflection that is visible to a driver of the vehicle as a virtual image.

In another embodiment, the invention comprises a display method for a motor vehicle, including emitting a light field based on image data. The light field is reflected with a first free form mirror to produce a first reflection. The first reflection of the light field is further reflected with a second free form mirror to produce a second reflection. The second reflection of the light field is further reflected with a windshield of the motor vehicle to produce a third reflection that is visible to a driver of the vehicle as a virtual image.

In yet another embodiment, the invention comprises a head up display arrangement for a motor vehicle. The arrangement includes an upper housing having an upwardly facing window, and a lower housing. The upper housing and the lower housing define therebetween a chamber. A picture generation unit generates an illuminated image and projects the illuminated image into the chamber. A first free form mirror is positioned within the chamber to provide a first reflection of the illuminated image. A second free form mirror is positioned within the chamber to receive the first reflection of the illuminated image and provide a second reflection of the illuminated image. The second free form mirror has a concave reflecting surface. A windshield of the motor vehicle is positioned to receive the second reflection of the illuminated image through the upwardly facing window of the upper housing, and to provide a third reflection that is visible to a driver of the vehicle as a virtual image.

An advantage of the present invention is that it provides a more compact package size that enables easier installation.

Another advantage is that using DLP technology with free form optics produces a WFOV with increased brightness levels and no reduction in image brightness when using polarized sunglasses.

Yet another advantage is that the increase in virtual image distance provided by the invention reduces driver distraction that otherwise occurs due to the driver having to change his focus between the HUD image and the scene on the roadway.

A further advantage is that the need for a wedged windshield is eliminated.

### BRIEF DESCRIPTION OF THE DRAWINGS

A better understanding of the present invention will be had upon reference to the following description in conjunction with the accompanying drawings.

FIG. 1 is an exploded perspective view of one example embodiment of a HUD arrangement of the present invention.

FIG. 2 is a top view of the HUD arrangement of FIG. 1.

FIG. 3 is a side cross-sectional view along line A-A in FIG. 2.

FIG. 4 is a side view of the HUD arrangement of FIG. 1.

FIG. 5 is a bottom view of the HUD arrangement of FIG. 1.

FIG. 6 is a flow chart of one embodiment of a display method of the present invention for a motor vehicle.

### DETAILED DESCRIPTION OF THE PREFERRED EMBODIMENTS

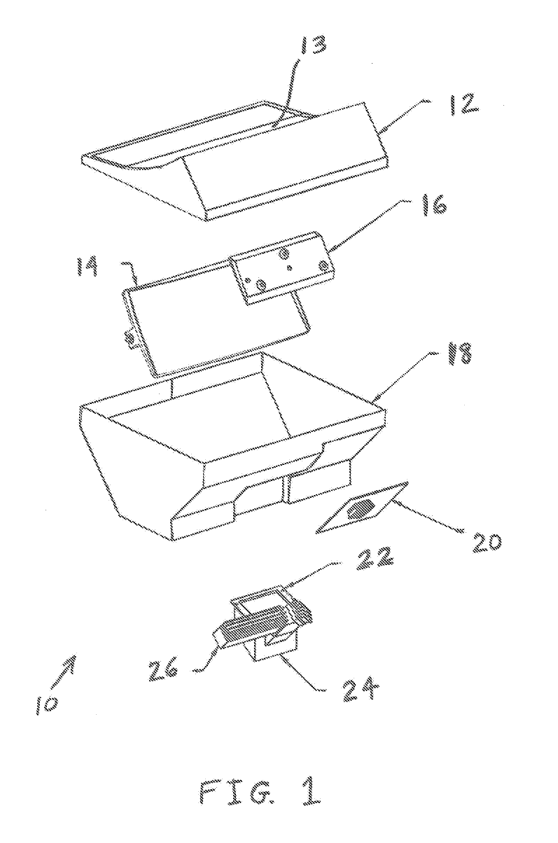

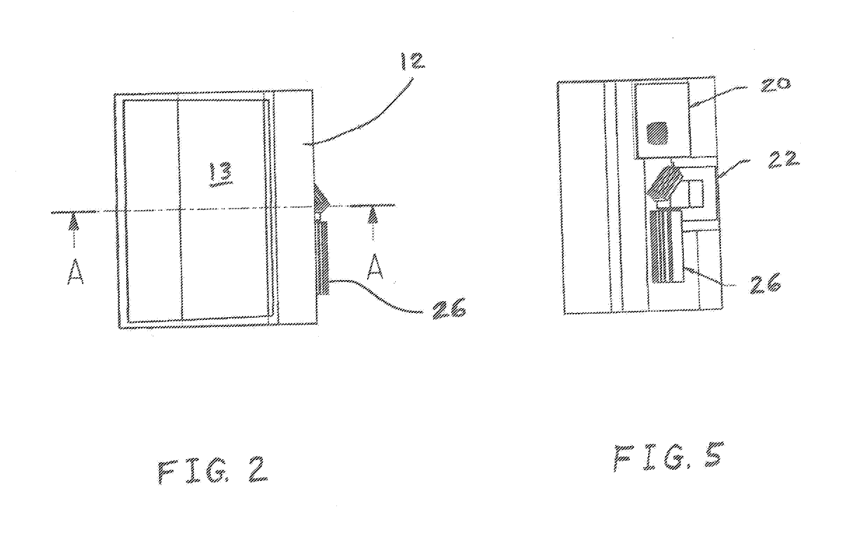

FIG. 1 illustrates one example embodiment of a HUD arrangement 10 of the present invention, including an upper housing 12, an M1 free form mirror 14, an M2 free form mirror 16, which is smaller than M1 free form mirror 14, a lower housing 18, a printed circuit board 20, a diffuser housing 22, a DLP PGU assembly 24, and a DLP optics housing 26.

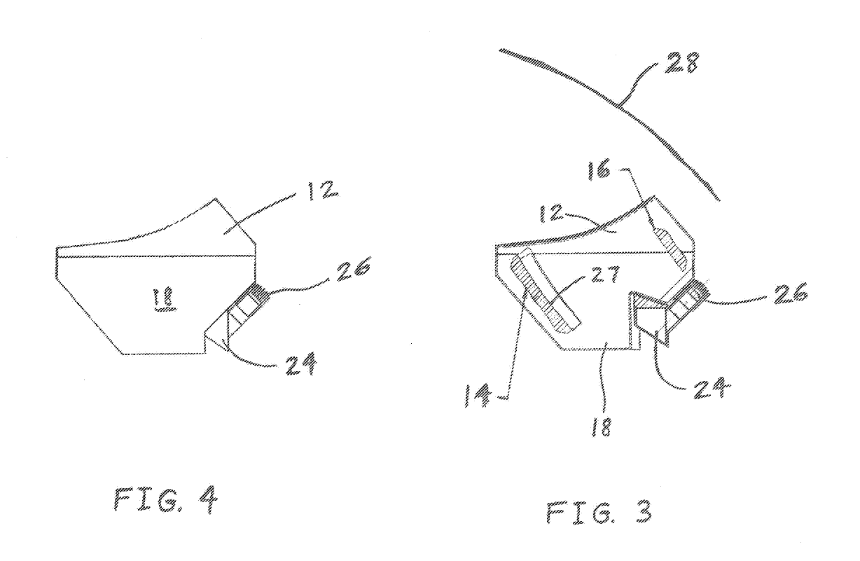

Upper housing 12 and lower housing 18 define therebetween a chamber in which mirrors 14, 16 are disposed. Upper housing 12 includes an upwardly-facing window 13. As best shown in FIG. 3, M1 Mirror 14 may have a concave reflective surface 27 which may reflect the image onto windshield 28 through window 13.

M1 Mirror 14 and its holder are mounted directly to the lower molded housing 18, avoiding the need for a separate mirror holder/mirror bracket. This may reduce the width of the HUD housing.

The mechanism to rotate M1 mirror 14 may be behind/below M1 mirror 14, thus eliminating the need for additional housing space if the mechanism is mounted to the side of M1 mirror 14.

The DLP PGU assembly 24 may have folded optics which are mounted on an angled surface and are not mounted to the bottom of the housing 26, thus reducing overall depth of the WFOV HUD unit.

The invention includes a symmetrical design where the center lines of the two free form mirrors 14, 16 and of the DLP PGU 24 are in line. This enables the same housings to be used for different vehicles by merely changing the mirrors.

An inventive heat sink design may reduce the amount of space required, increase cooling efficiency, and reduce cost.

Orientation of the PGU folded Optics and the PCBs at an angle promotes convective air flow between the heat sink fins, thus increasing cooling efficiencies.

The invention utilizes image warping at the PGU to produce a virtual image with minimum overall distortion.

The DLP PGU 24 may be a modular assembly including a diffuser assembly housing 22 that is attached to the DLP assembly housing 26. The DLP assembly housing 26 includes the light sources, the DLP digital micromirror device (DMD), optics and focusing lens to project the image onto the diffuser in the diffuser housing assembly 22. The diffuser housing assembly 22 can have differing configurations depending on HUD requirements and HUD configurations, which may include diffuser size and performance, fold mirror size and orientation, and housing mounting, angle and size.

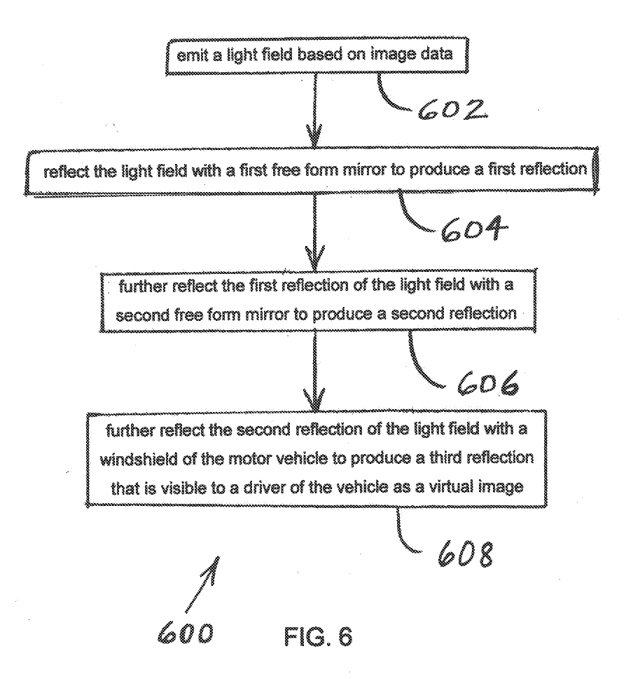

FIG. 6 illustrates one embodiment of a display method 600 of the present invention for a motor vehicle. In a first step 602, a light field is emitted based on image data. For example, DLP PGU assembly 24 may emit a light field based on image data received from an electronic processor (not shown).

Next, in step 604, the light field is reflected with a first free form mirror to produce a first reflection. For example, the light field emitted by DLP PGU assembly 24 may be reflected by M2 free form mirror 16 to produce a first reflection.

In a next step 606, the first reflection of the light field is father reflected with a second free form mirror to produce a second reflection. For example, the first reflection from M2 free form mirror 16 may be further reflected by M1 Mirror 14 to produce a second reflection.

In a final step 608, the second reflection of the light field is further reflected with a windshield of the motor vehicle to produce a third reflection that is visible to a driver of the vehicle as a virtual image. For example, the second reflection from M1 Mirror 14 may be further reflected by windshield 28 to produce a third reflection that is visible to a driver of the vehicle as a virtual image.

The foregoing description may refer to “motor vehicle”, “automobile”, “automotive”, or similar expressions. It is to be understood that these terms are not intended to limit the invention to any particular type of transportation vehicle. Rather, the invention may be applied to any type of transportation vehicle whether traveling by air, water, or ground, such as airplanes, boats, etc.

The foregoing detailed description is given primarily for clearness of understanding and no unnecessary limitations are to be understood therefrom for modifications can be made by those skilled in the art upon reading this disclosure and may be made without departing from the spirit of the invention.

What is claimed is:

1. A head up display arrangement for a motor vehicle, the arrangement comprising:
a picture generation unit configured to generate an illuminated image;
a first free form mirror positioned to provide a first reflection of the illuminated image;
a second free form mirror positioned to receive the first reflection of the illuminated image and provide a second reflection of the illuminated image; and
a windshield of the motor vehicle positioned to receive the second reflection of the illuminated image and provide a third reflection that is visible to a driver of the vehicle as a virtual image.

2. The head up display arrangement of claim 1 wherein the second free form mirror has a concave reflecting surface.

3. The head up display arrangement of claim 1 wherein a first center line of the picture generation unit, a second center line of the first free form mirror, and a third center line of the second free form mirror are substantially aligned with each other.

4. The head up display arrangement of claim 1 wherein the picture generation unit includes an optical element that is mounted to an angled surface of a housing, the angled surface being oriented at a first angle of approximately between twenty degrees and seventy degrees relative to a horizontal orientation.

5. The head up display arrangement of claim 4 wherein the picture generation unit includes a heat sink having a plurality of parallel fins, the fins being oriented at a second angle of approximately between twenty degrees and seventy degrees relative to the horizontal orientation.

6. The head up display arrangement of claim 5 further comprising an upper housing and a lower housing defining therebetween a chamber, the first mirror and the second mirror being disposed within the chamber, the angled surface being disposed on the lower housing.

7. The head up display arrangement of claim 6 wherein the lower housing includes a V-shaped notch opening in a generally downward direction, the picture generation unit being at least partially received in the V-shaped notch.

8. A display method for a motor vehicle, the method comprising:
emitting a light field based on image data;
reflecting the light field with a first free form mirror to produce a first reflection;
further reflecting the first reflection of the light field with a second free form mirror to produce a second reflection; and
further reflecting the second reflection of the light field with a windshield of the motor vehicle to produce a third reflection that is visible to a driver of the vehicle as a virtual image.

9. The display method of claim 8 wherein the second free form minor has a concave reflecting surface.

10. The display method of claim 8 wherein the light field is emitted by a picture generation unit, a first center line of the picture generation unit, a second center line of the first free form mirror, and a third center line of the second free form mirror being substantially aligned with each other.

11. The display method of claim 10 wherein the picture generation unit includes an optical element that is mounted to an angled surface of a housing, the angled surface being oriented at a first angle of approximately between twenty-five degrees and sixty-five degrees relative to a horizontal orientation.

12. The display method of claim 11 wherein the picture generation unit includes a heat sink having a plurality of parallel fins, the fins being oriented at a second angle of approximately between twenty-five degrees and sixty-five degrees relative to the horizontal orientation.

13. The display method of claim 11 further comprising providing an upper housing and a lower housing defining therebetween a chamber, the first mirror and the second mirror being disposed within the chamber, the angled surface being disposed on the lower housing.

14. The display method of claim 13 wherein the lower housing includes a V-shaped notch opening in a generally downward direction, the picture generation unit being at least partially received in the V-shaped notch.

15. A head up display arrangement for a motor vehicle, the arrangement comprising:
an upper housing having an upwardly facing window;
a lower housing, the upper housing and the lower housing defining therebetween a chamber;
a picture generation unit configured to generate an illuminated image and project the illuminated image into the chamber;
a first free form mirror positioned within the chamber to provide a first reflection of the illuminated image;
a second free form minor positioned within the chamber to receive the first reflection of the illuminated image and provide a second reflection of the illuminated image, the second free form mirror having a concave reflecting surface; and
a windshield of the motor vehicle positioned to receive the second reflection of the illuminated image through the upwardly facing window of the upper housing, and provide a third reflection that is visible to a driver of the vehicle as a virtual image.

16. The head up display arrangement of claim 15 wherein a first center line of the picture generation unit, a second center line of the first free form mirror, and a third center line of the second free form mirror are substantially aligned with each other.

17. The head up display arrangement of claim 15 wherein the picture generation unit includes an optical element that is mounted to an angled surface of the lower housing

18. The head up display arrangement of claim 17 wherein the angled surface is oriented at a first angle of approximately between thirty degrees and sixty degrees relative to a horizontal orientation.

19. The head up display arrangement of claim 18 wherein the picture generation unit includes a heat sink having a plurality of parallel fins, the fins being oriented at a second angle of approximately between twenty degrees and seventy degrees relative to the horizontal orientation.

20. The head up display arrangement of claim 15 wherein the lower housing includes a V-shaped notch opening in a generally downward direction, the picture generation unit being at least partially received in the V-shaped notch.
